(19) United States
(12) Patent Application Publication
(10) Pub. No.: US 2020/0079488 A1
(43) Pub. Date: Mar. 12, 2020

(54) UNMANNED AERIAL VEHICLE WITH ISOLATED COMPONENTS

(71) Applicant: Airspace Systems, Inc., San Leandro, CA (US)

(72) Inventors: Tyson Messori, Alameda, CA (US); Guy Bar-Nahum, Sausalito, CA (US)

(21) Appl. No.: 16/123,960

(22) Filed: Sep. 6, 2018

(51) Int. Cl. B64C 1/06; B64C 39/02; B64C 27/00; B64D 45/00

(52) U.S. Cl. CPC B64C 1/061; B64C 39/024; B64C 27/001; B64C 2027/002; B64C 2201/12; B64C 2201/108; B64D 45/00

(57) ABSTRACT

An aerial vehicle system includes a signal generator, a plurality of computing components, a plurality of communication antennas, a first structural component configured to at least in part block a noise signal generated by the signal generator from the plurality of computing components, and a second structural component configured to at least in part block the noise signal generated by the signal generator from the plurality of communication antennas, wherein the first structural component and the second structural component form a portion of a structural frame of the aerial vehicle system.

### BACKGROUND OF THE INVENTION

Unmanned Aerial Platforms, including Unmanned Aerial Vehicles (UAV) and Aerial Drones, may be used for a variety of applications. However, some applications may pose a risk to people or property. UAVs have been used to carry contraband, including drugs, weapons, and counterfeit goods across international borders. It is further possible that UAVs may be used for voyeuristic or industrial surveillance, to commit terrorist acts such as spreading toxins, or transporting an explosive device. In view of this risk posed by malicious UAVs, it may be necessary to have a system to intercept, capture, and transport away a UAV that has entered a restricted area.

### BRIEF DESCRIPTION OF THE DRAWINGS

Various embodiments of the invention are disclosed in the following detailed description and the accompanying drawings.

FIG. 1 is a diagram illustrating a front view of an unmanned aerial vehicle in accordance with some embodiments.

FIG. 2 is a diagram illustrating a side view of an unmanned aerial vehicle in accordance with some embodiments.

FIG. 3 is a diagram illustrating a view of a top portion of an unmanned aerial vehicle in accordance with some embodiments.

FIG. 4 is a diagram illustrating a top view of a top portion of an unmanned aerial vehicle in accordance with some embodiments.

FIG. 5 is a diagram illustrating a side view of an unmanned aerial vehicle in accordance with some embodiments.

FIG. 6 is a diagram illustrating a view of a noise isolation plates of an unmanned aerial vehicle in accordance with some embodiments.

FIG. 7 is a diagram illustrating a side view of an unmanned aerial vehicle.

FIG. 8A is a diagram illustrating rotor arm clips in accordance with some embodiments.

FIG. 8B is a diagram illustrating rotor arm clips in accordance with some embodiments.

FIG. 9 is a diagram illustrating a vibration damper in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

An unmanned aerial vehicle (UAV) (e.g., drone) is an aircraft without a human pilot aboard the vehicle. A UAV may be remotely controlled by a human operator or autonomously controlled by on-board computers. UAVs are typically used to perform various tasks, such as surveillance, aerial photography, product deliveries, racing, etc. UAVs have become ubiquitous. Unintended uses for UAVs have emerged. For example, UAVs have been used to carry contraband, including drugs, weapons, and counterfeit goods across international borders. It is further possible that UAVs may be used for voyeuristic or industrial surveillance, to commit terrorist acts such as spreading toxins, or to transport an explosive device. Conventional techniques to disable a UAV include shooting down the UAV from the ground. However, such a technique risks bodily harm and/or property damage when the UAV crashes.

A UAV may be disabled and/or captured by another UAV. A defending UAV may include a detector to determine that a flying object is a UAV, a jamming system to disable a target UAV, and an interdiction system to automatically capture the target UAV when the target UAV is disabled. A UAV is comprised of a plurality of mechanical components (e.g., motors, rotors, etc.), a plurality of computing components (e.g., CPU, flight controller, interdiction control system, etc.), and a plurality of radiating components (e.g., antennas, RADAR, LIDAR, SONAR, etc.). Each component of the UAV is necessary for the UAV to function properly.

The plurality of mechanical components may cause the components of the UAV to vibrate. As a result, one or more components of the UAV may fail. For example, two or more components of the UAV may stop communicating because a connection between two or more components of the UAV has become loose. The UAV may be battery powered and the battery may lose contact with the other components of the UAV because of the vibrations. As a result, the rotors of the UAV may stop rotating and cause the UAV to crash. The plurality of UAV components may be attached to the UAV using one or more fasteners. The vibrations caused by the mechanical components may cause the one or more fasteners to become loose. When the UAV is flying, the vibrations caused by the mechanical components may cause one or more UAV components to lose a connection, or even worse, become displaced from the UAV.

The plurality of computing components may produce noise. For example, the different computing components may produce crosstalk, which is a phenomenon in which a signal transmitted in one circuit or channel of a first system creates undesired interference onto a signal in another channel. The noise may prevent a computing component from functioning properly because the signal is too noisy for the computing component to recognize the signal.

The plurality of radiating components may produce electromagnetic interference (EMI). The EMI may cause an electrical circuit to degrade or even stop functioning. For example, a radio system and/or a communication signal generator of the UAV may produce EMI that prevents other computing components from properly functioning.

The mechanical vibrations, electrical noise, and/or EMI may prevent a UAV from functioning properly. For example, a signal captured by a visual detection system may be too noisy for the visual detection system to detect an object and/or classify the detected object as a UAV. The vibrations caused by a motor and/or rotor may cause a battery connection to become loose causing the computing components of the UAV to lose power. The UAV may include an interdiction system that is configured to deploy one or more nets to capture a target UAV based on one or more signals received from one or more sensors. The signals received from the one or more sensors may be too noisy may prevent the interdiction system from precisely deploying the one or more nets.

A UAV may be designed to include an isolation module comprising a plurality of isolation plates configured to isolate the computing components from the radiating devices. At least one of the isolation plates may also be coupled to one or more dampers to reduce an amount of vibration to which the plurality of computing components and the plurality of radiating devices are subjected. The isolation plates may isolate one or more high noise generating components of the UAV from the other components of the UAV. For example, a radio communications system and a communication disruption signal generator may be isolated from a plurality of computing components and a plurality of antennas. An isolation plate may also be configured to act as a ground plane for the antennas of the UAV. As a result, the influence that vibrations, noise, and EMI have on the overall performance of the UAV is reduced.

The UAV may be designed to include a structural frame comprising a plurality of isolation plates that may not only isolate different components from noise, but also serve as a structural component for the UAV. For example, the structural isolation plates may be coupled to each other via a plurality of brackets attached to corresponding rotor arms of the UAV and a plurality of side wall components. The structural isolation plates in combination with the plurality of brackets and the plurality of side wall components are configured to hold the UAV together. The structural frame may include a plurality of openings. A top isolation plate of the structural frame may include a plurality of dampers. The top isolation pate of the structural frame may be coupled to one of isolation plates of the isolation module via the plurality of dampers. A second isolation plate of the isolation module may be positioned in between the top structural isolation plate and a bottom structural isolation plate via one of the plurality of openings of the structural frame.

The computing components and radiating devices may be fastened into one of the isolation plates. The radiating components of the UAV may be placed between a top structural isolation plate and a bottom structural isolation plate, causing the two structural isolation plates to act like a Faraday cage for the radiating components. The top structural isolation plate may be coupled to a top isolation plate of the vibration isolation module. A plurality of dampers may be located in between the top structural isolation plate and the top isolation plate of the vibration isolation module. The plurality of computing components may be placed on a top side of the top isolation plate of the vibration isolation module. The top structural isolation plate in combination with the top isolation plate of the vibration isolation module and the plurality of dampers shield the plurality of computing components from vibrations, noise, and EMI. The plurality of antennas may be placed on a bottom side of the bottom structural isolation plate. The bottom structural isolation plate shields the plurality of antenna elements from vibrations, noise, and EMI. The bottom structural isolation plate also serves as a ground plane for the plurality of antenna elements.

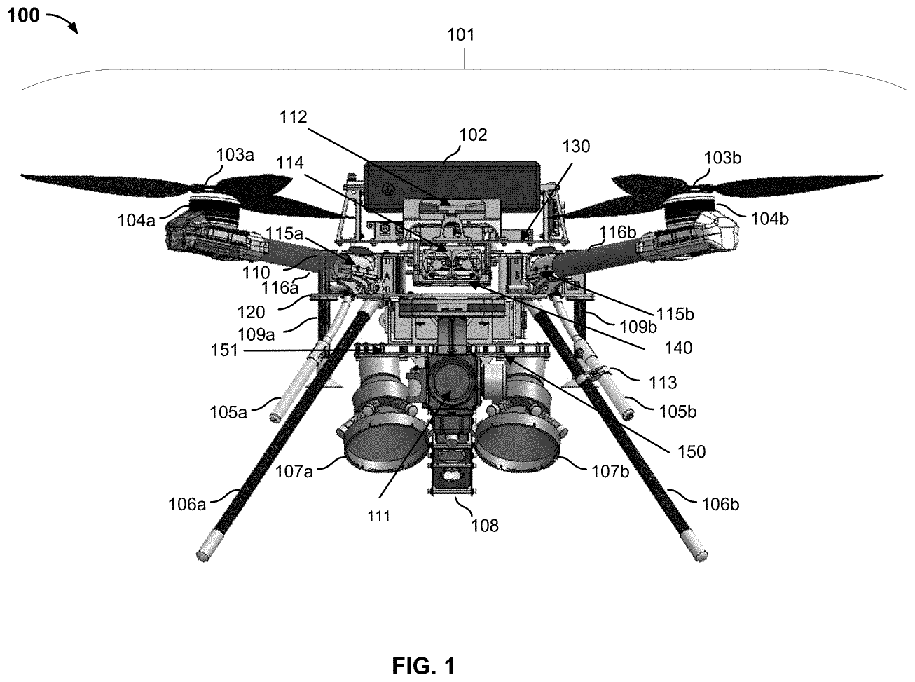

FIG. 1 is a diagram illustrating a front view of an unmanned aerial vehicle in accordance with some embodiments. In the example shown, front view 100 includes unmanned aerial vehicle 101 comprising computing chassis 102, first rotor 103a, second rotor 103b, first motor 104a, second motor 104b, first antenna 105a, second antenna 105b, first landing strut 106a, second landing strut 106b, first net launcher 107a, second net launcher 107b, first guide collar 109a, second guide collar 109b, interdiction sensor module 108, first structural isolation plate 110, visual detection system 111, disruption signal antenna 112, antenna clip 113, one or more cooling fans 114, first rotor arm bracket 115a, second rotor arm bracket 115b, first rotor arm 116a, second rotor arm 116b, second structural isolation plate 120, vibration isolation plate 130, vibration isolation plate 140, vibration isolation plate 150, and dampers 151.

Computing chassis 102 is configured to protect the CPU of UAV 101. The CPU is configured to control the overall operation of UAV 101. The CPU may be coupled to a plurality of computing modules. For example, the plurality of computing modules may include an interdiction control module, an image processing module, a safety module, a flight recorder module, etc. The CPU may provide one or more control signals to each of the plurality of computing modules. For example, the CPU may provide a control signal to the interdiction control module to activate one of the net launchers 107a, 107b to deploy a net. The CPU may provide a control signal to the image processing module to process an image captured by the visual detection system 111. The CPU may be configured to perform one or more flight decisions for the UAV. For example, the CPU may provide one or more flights commands to a flight controller module. For example, a flight command may include a specified speed for the UAV, a specified flight height for the UAV, a particular flight path for the UAV, etc. In response to the one or more flight commands, the flight controller module is configured to control the motors associated with the UAV (e.g., motors 104a, 104b) so that UAV 101 flies in a manner that is consistent with the flight commands. In some embodiments, the CPU is configured to receive flight instructions from a remote command center. In other embodiments, the CPU is configured to autonomously fly UAV 101.

The image processing module is configured to process images acquired by visual detection system 111. The image processing module may be configured to determine whether a visually detected object is a UAV based on the visual data associated with the detected object. The image processing module may include a plurality of machine learning models that are trained to label a detected object based on the visual data. For example, the image processing module may include a first machine learning model that is configured to label objects as a UAV, a second machine learning model that is configured to label objects as a bird, a third machine learning model that is configured to label objects as a plane, etc.

First structural isolation plate 110 is configured to isolate computing chassis 102 and its associated computing components from one or more noisy components. First structural isolation plate 110 is also configured to isolate the one or more noisy components from the electromagnetic interference noise associated with the computing components of computing chassis 102. The one or more noisy components isolated from computing chassis 102 and its associated computing components by first structural isolation plate 110 may include may include a communications radio (not shown in the front view) and a communications disruption signal generator (not shown in the front view).

First structural isolation plate 110 may include a foil made from a particular metallic material (e.g., copper) and the foil may have a particular thickness (e.g., 0.1 mm). First structural isolation plate 110 and second structural isolation plate 120 may act as a structural frame for UAV 101. First structural isolation plate 110 may be coupled to second structural isolation plate 120 via a plurality of rotor arm brackets (e.g., rotor arm brackets 115a, 115b) and a plurality of side wall components (not shown in the front view). The rotor arm brackets are coupled to a corresponding rotor arm. The first structural isolation plate 110 may be attached to one or more rotor arm clips (not shown in the front view). The one or more rotor arm clips are configured to lock and unlock corresponding rotor arms of UAV 101. The one or more rotor arm clips are configured to lock the rotor arms in a flight position when UAV 101 is flying. The one or more rotor arm clips are configured to unlock the rotor arms from a flight position when UAV 101 is not flying. For example, the rotor arms may be unlocked from the rotor arm clips when UAV 101 is being stored or transported to different locations.

First structural isolation plate 110 is coupled to vibration isolation plate 130 via a plurality of vibration dampers. First structural isolation plate 110 may be coupled to one or more dampers configured to reduce the amount of vibration to which a plurality of vibration sensitive components are subjected. The plurality of vibration sensitive components may include the computing modules included in computing chassis 102, connectors, and heat sinks. The performance of the vibration sensitive components may degrade when subjected to vibrations. The one or more dampers may be omnidirectional dampers. The one or more dampers may be tuned to the specific frequency associated with a vibration source. The vibrations may be mechanical vibrations caused by the motors of the UAV (e.g., motors 104a, 104b) and the rotors of the UAV (e.g., rotors 103a, 103b). First structural isolation plate 110 in combination with vibration isolation plate 130 and the plurality of dampers are configured to shield the plurality of computing components from vibrations, noise, and EMI.

Vibration isolation plate 130 is coupled to antenna 112 associated with a communications disruption signal generator. Antenna 112 may be a highly directional antenna (e.g., log periodic, parabolic, helical, yagi, phased array, horn, etc.) that is configured to transmit a communications disruption signal. The communications disruption signal may have a frequency associated with one or more wireless communications devices that the communications disruption signal is attempting to disrupt. For example, the communications disruption signal may have a frequency between 2.1 GHz and 5.8 GHz.

UAV 101 includes second structural isolation plate 120. A UAV may also be designed to include an isolation plate to isolate the noisy components from the radiating components and vice versa. Second structural isolation plate 120 is configured to isolate the one or more noisy components from one or more antennas and one or more sensors and vice versa. Second structural isolation plate 120 is also configured to act as a ground plane for the one or more antennas associated with a radio communications system of UAV 101.

Structural isolation plate 120 may also be coupled to one or more dampers to reduce an amount of vibration to which the noisy components are subjected. The combination of structural isolation plate 110 and structural isolation plate 120 act as a Faraday cage for the noisy components. The combination of structural isolation plate 110 and structural isolation plate 120 are configured to isolate one or more high noise generating components of the UAV from the other components of the UAV. For example, a radio communications system and a communication disruption signal generator may be isolated from a plurality of computing components and a plurality of antennas. As a result, the influence that vibrations, noise, and EMI have on the overall performance of the UAV is reduced. One or more cooling fans 114 are coupled to and may be positioned in between vibration isolation plate 130 and vibration isolation plate 140. The high noise generating components of the UAV may generate a lot of heat during operation. One or more cooling fans 114 are configured to direct air towards the high noise generating components such that a temperature of the high noise generating components of the UAV is reduced during operation. A portion of the one or more cooling fans 114 may be placed adjacent to one of the openings of the structural frame comprising first structural isolation plate 110 and second structural isolation plate 120.

First rotor arm bracket 115a is coupled to first rotor arm 116a and second rotor arm bracket 116a is coupled to second rotor arm 116b. First rotor arm 116a is coupled to motor 104a and rotor 103a. Second rotor arm 116b is coupled to motor 104b and rotor 103b. Rotor arm brackets 115a, 115b are configured to engage rotor arms 116a, 116b, respectively. UAV 101 may lift off from a launch location and fly when rotor arms 116a, 116b are engaged with their corresponding rotor arm brackets 115a, 115b. When rotor arms 116a, 116b are engaged with their corresponding rotor arm brackets 115a, 115b, motors 104a, 104b may provide a control signal to rotors 103a, 103b to rotate.

A radio communications system of UAV 101 may be associated with a plurality of antennas (e.g., antenna 105a, antenna 105b). Each antenna may operate at a different frequency. This enables the radio communications system to switch between frequency channels to communicate. The radio communications system may communicate with a remote server via antenna 105a. For example, the radio communications system may transmit the data associated with the one or more sensors associated with UAV 101 (e.g., radar data, lidar data, sonar data, image data, etc.). The frequency channel associated with antenna 105a may become noisy. In response to the frequency channel associated with antenna 105a becoming noisy, the radio communications system may switch to a frequency channel associated with antenna 105b. The antennas associated with the radio communications system may be daisy chained together. The persistent systems radio may communicate with one or more other UAVs and transmit via antennas 105a, 105b, a signal back to a source through the one or more other UAVs. For example, another UAV may act as an intermediary between UAV 101 and a remote server. UAV 101 may be out of range from the remote server to communicate using antennas 105a, 105b, but another UAV may in range to communicate with UAV 101 and in range to communicate with the remote sever. UAV 101 may transmit the data associated with one or more sensors to the other UAV, which may forward the data associated with one or more sensors to the remote server.

The radio communications system of UAV 101 may be associated with three antennas (e.g., antenna 105a, antenna 105b, antenna 205c). The antennas may be approximately 90 degrees apart from each other (e.g., 90°±5°). The antennas may be coupled to the landing struts of UAV 101 (e.g., landing strut 106a, landing strut 106b, landing strut 206c) via an antenna clip, such as antenna clip 113. This allows the antennas to have a tripod configuration, which allows the antennas to have enough fidelity to transmit the needed bandwidth of data. For example, the tripod configuration allows the antennas to have sufficient bandwidth to transmit video data or any other data obtained from the one or more sensors of UAV 101.

UAV 101 may include a fourth antenna (not shown) that is also coupled to one of the landing struts of UAV 101. UAV 101 may be remotely controlled and the fourth antenna may be used for remote control communications. In some embodiments, the antennas coupled to the landing struts of UAV 101 may be integrated into the landing strut, such that an antenna is embedded within a landing strut.

UAV 101 may include guide collars 109a, 109b. Guide collars 109a, 109b may be coupled to a plurality of launch rails. UAV 101 may be stored in a hangar that includes the plurality of launch rails. Guide collars 109a, 109b are hollow and may be configured to slide along the launch rails to constrain lateral movement of UAV 101 until it has exited the housing or hangar.

UAV 101 may include a vibration plate 150 that is coupled to a battery cage via a plurality of dampers 151. The vibration plate 150 may be coupled to net launchers 107a, 107b and interdiction sensor system 108. Interdiction sensor system 108 may include at least one of a global positioning system, a radio detection and ranging (RADAR) system, a light detection and ranging (LIDAR) system, a sounded navigation and ranging (SONAR) system, an image detection system (e.g., photo capture, video capture, UV capture, IR capture, etc.), sound detectors, one or more rangefinders, etc. For example, eight LIDAR or RADAR beams may be used in the rangefinder to detect proximity to the target UAV. Interdiction sensor system 108 may include one or more LEDs that indicate to bystanders whether UAV 101 is armed and/or has detected a target. The one or more LEDs may be facing away from the back of UAV 101 and below UAV 101. This enables one or more bystanders under UAV 101 to become aware of a status associated with UAV 101.

Interdiction sensor system 108 may include image capture sensors which may be controlled by the interdiction control module to capture images of the object when detected by the range finding sensors. Based on the captured image and the range readings from the ranging sensors, the interdiction control module may identify whether or not the object is a UAV and whether the UAV is a UAV detected by one of the sensor systems.

When the interdiction control module determines that the object is a target UAV, it may also determine if the target UAV is an optimal capture position relative to the defending UAV. The position between UAV 101 and the target UAV may be determined based on one or more measurements performed by interdiction sensor system 108. If the relative position between the target UAV and the defending UAV is not optimal, interdiction control module may provide a recommendation or indication to the remote controller of the UAV. An interdiction control module may provide or suggest course corrections directly to the flight controller module to maneuver UAV 101 into an ideal interception position autonomously or semi-autonomously. Once the ideal relative position between the target UAV and the defending UAV is achieved, the interdiction control module may automatically trigger one of the net launchers 107a, 107b. Once triggered, one of the net launchers 107a, 107b may fire a net designed to ensnare the target UAV and disable its further flight.

The net fired by the capture net launcher may include a tether connected to UAV 101 to allow UAV 101 to move the target UAV to a safe area for further investigation and/or neutralization. The tether may be connected to the defending UAV by a retractable servo controlled by the interdiction control module such that the tether may be released based on a control signal from the interdiction control module. The CPU of the UAV may be configured to sense the weight, mass, or inertia effect of a target UAV being tethered in the capture net and recommend action to prevent the tethered target UAV from causing UAV 101 to crash or lose maneuverability. For example, the CPU may recommend UAV 101 to land, release the tether, or increase thrust. The CPU may provide a control signal to allow the UAV to autonomously or semi-autonomously take corrective actions, such as initiating an autonomous or semi-autonomous landing, increasing thrust to maintain altitude, or releasing the tether to jettison the target UAV in order to prevent the defending UAV from crashing.

UAV 101 may include visual detection system 111. Visual detection system 111 may include one or more cameras. Visual detection system 111 may be used by a remote operator to control a flight path associated with UAV 101. Visual detection system 111 may provide visual data to an image processing module configured to visually detect an object and provide visual data (e.g., pixel data) to one or more machine learning models. The one or more machine learning models may be trained to label an object as a UAV based on the visual data. The image processing module may provide an output indicating that an object is labeled as a UAV to the interdiction control module. The interdiction control module may be configured to activate net launchers 107a, 107b based on the label. For example, in the event the visually detected object is labeled a UAV and the visually detected object is within a threshold range from UAV 101, the interdiction control module may output a control signal that causes one of the net launchers 107a, 107b to deploy a net.

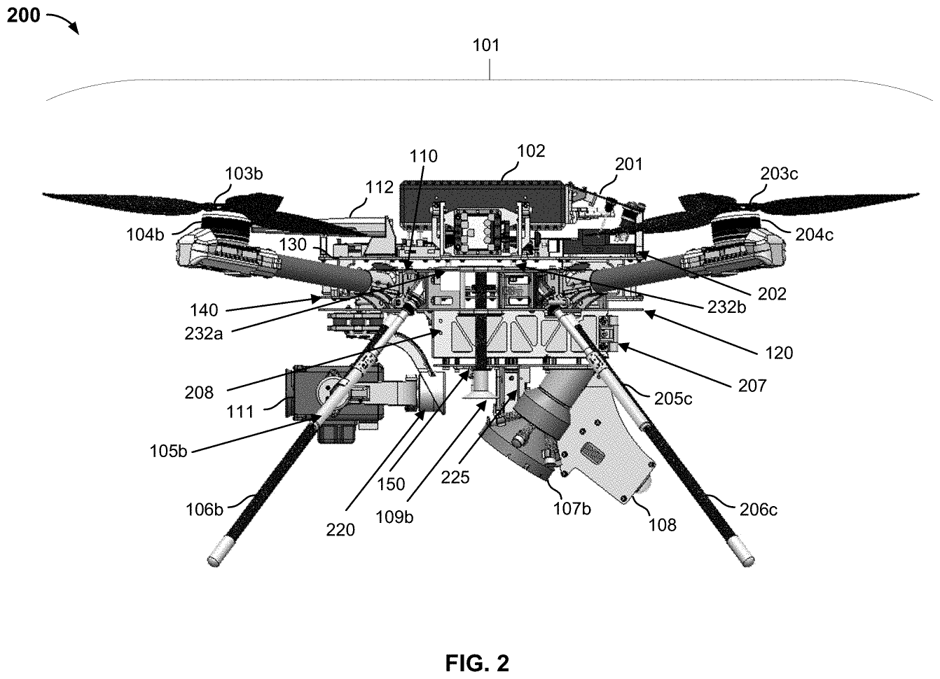

FIG. 2 is a diagram illustrating a side view of an unmanned aerial vehicle in accordance with some embodiments. In the example shown, side view 200 includes unmanned aerial vehicle 101 comprising computing chassis 102, UI panel 201, flight controller module 202, second rotor 103b, third rotor 203c, second motor 104b, third motor 204c, second antenna 105b, third antenna 205c, second landing strut 106b, third landing strut 206c, battery 207, battery cage 208, second net launcher 107b, interdiction sensor module 108, second guide collar 109b, first structural isolation plate 110, visual detection system 111, disruption signal antenna 112, antenna clip 113, second structural isolation plate 120, gimbal 220, tether mechanism 225, and vibration dampers 232a, 232b, isolation plate 150, vibration isolation plate 140, and vibration isolation plate 150.

UI panel 201 is coupled a safety module that is included in computing chassis 102. UI panel 201 comprises one or more switches, knobs, buttons that enables an operator to arm and disarm UAV 101. An operator may interact with UI panel 201 and based on the operator interactions, the safety module is configured to arm/disarm UAV 101. For example, first net launcher 107a and second net launcher 107b may be disarmed based on one or more interactions of an operator with UI panel 201. This may allow the operator to inspect and/or perform maintenance on UAV 101.

Flight controller module 202 is configured to control a flight of UAV 101. The flight controller module may provide one or more control signals to the one or more motors (e.g., 104a, 104b) associated with UAV 101. The one or more control signals may cause a motor to increase or decrease its associated revolutions per minute (RPM). UAV 101 may be remotely controlled from a remote location. UAV 101 may include an antenna that receives flight control signals from the remote location. In response to receiving the flight control signals, the CPU of UAV 101 may determine how UAV 101 should fly and provide control signals to flight controller module 202. In response to the control signals, flight control 202 is configured to provide control signals to the one or more motors associated with UAV 101, causing UAV 101 to maneuver as desired by an operator at the remote location.

Antenna 205c is coupled to landing strut 206c. Antenna 205c is one of the antennas associated with a communications radio system of UAV 101. Antenna 205c is configured to operate at a frequency that is different than antennas 105a, 105b. A communications radio system may be configured to switch between frequency channels to communicate. The communications radio system may communicate with a remote server via antenna 105a. The frequency channel associated with antenna 105a may become noisy. For example, the radio communications system may transmit the data associated with the one or more sensors associated with UAV 101 (e.g., radar data, lidar data, sonar data, image data, etc.). In response to the frequency channel associated with antenna 105a becoming noisy, the radio communications system may switch to a frequency channel associated with antenna 105b. The frequency channel associated with antenna 105b may become noisy. In response to the frequency channel associated with antenna 105b becoming noisy, the radio communications system may switch to a frequency channel associated with antenna 205c.

Battery 207 is configured to provide power to UAV 101. UAV 101 is comprised of a plurality of components that require electricity to operate. Battery 207 is configured to provide power to the plurality of components. In some embodiments, battery 207 is a rechargeable battery. Battery 207 is housed within battery cage 208. Battery cage 208 may be coupled to vibration isolation plate 150 via a plurality of dampers. Vibration isolation plate 150 may be coupled to interdiction sensor module 108, net launchers 107a, 107b, tether mechanism 225, and a persistent availability plug.

Gimbal 220 is coupled to visual detection system 111 and second structural isolation plate 120. A gimbal is a pivoted support that allows the rotation of visual detection system 111 about a single axis. Gimbal 220 is configured to stabilize an image captured by visual detection system 111.

Tether mechanism 225 is coupled to net capture launchers 107a, 107b. When a net is deployed by one of the net capture launchers 107a, 107b, the net remains tethered to UAV 101 via tether mechanism 225. Tether mechanism 225 may be configured to sense the weight, mass, or inertia effect of a target UAV being tethered in the capture net. In response to the sensed signals, a CPU of UAV 101 may be configured to recommend action to prevent the tethered target UAV from causing UAV 101 to crash or lose maneuverability. For example, the CPU of UAV 101 may recommend UAV 101 to land, release the tether, or increase thrust. The CPU of UAV 101 may provide a control signal to allow the UAV to autonomously or semi-autonomously take corrective actions, such as initiating an autonomous or semi-autonomous landing, increasing thrust to maintain altitude, or releasing the tether to jettison the target UAV in order to prevent the defending UAV from crashing.

Vibration dampers 232a, 232b are coupled to structural isolation plate 110 and vibration isolation plate 130. Vibration dampers 232a, 232b may be omnidirectional dampers. Vibration dampers 232a, 232b may be configured to reduce the amount of vibration to which a plurality of vibration sensitive components are subjected. The plurality of vibration sensitive components may include different electronics modules (e.g., components included in computing chassis 102, connectors, and heat sinks. The performance of the vibration sensitive components may degrade when subjected to vibrations. Vibration dampers 232a, 232b may be tuned to the specific frequency associated with a vibration source. The vibrations may be mechanical vibrations caused by the motors of the UAV (e.g., motors 104a, 104b) and the rotors of the UAV (e.g., rotors 103a, 103b). Vibration damper 232a, 232b may be tuned to the mechanical vibrations caused by the motors of the UAV and the rotors of the UAV. Vibration dampers 232a, 232b may be comprised of a vibration damping material, such as carbon fiber. In some embodiments, one or more vibration dampers may be included in between a motor and a motor mount.

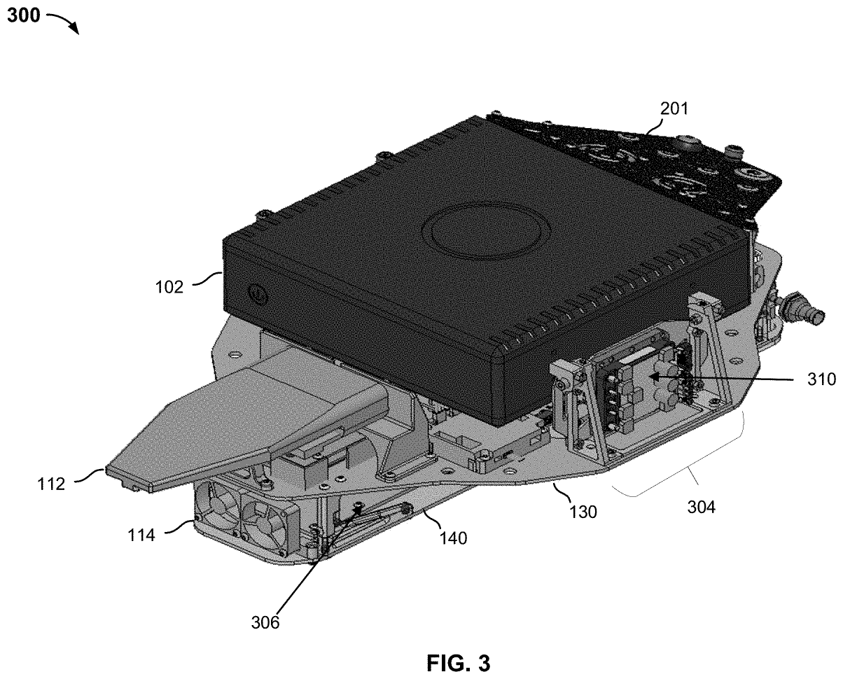

FIG. 3 is a diagram illustrating a view of a top portion of an unmanned aerial vehicle in accordance with some embodiments. In the example shown, view 300 includes computing chassis 102, UI panel 201, disruption signal antenna 112, cooling fans 114, vibration isolation plate 130, vibration isolation plate 140, electronics retention folding mechanism 304, disruption signal generator 306, and power supply 310.

Electronics retention folding mechanism 304 is hinge mounted to computing chassis 102 and UI panel 201. Electronics retention folding mechanism 304 is configured to pivot ninety degrees such that computing chassis 102 is rotated ninety degrees. This enables an operator of the UAV to performance maintenance on one or more components that between first structural isolation plate 110 and computing chassis 102.

Electronics retention folding mechanism 304 may include one or more fasteners that couples computing chassis 102 to electronics retention folding mechanism 304. The one or more fasteners may include screws, bolts, clips, etc. Computing chassis 102 may be decoupled from electronics retention folding mechanism 304 by loosening and removing the one or more fasteners.

In addition to electronics retention folding mechanism, a resting bracket (not shown) may support computing chassis 102 on a side opposite of electronics retention folding mechanism 304. When resting on the resting bracket, computing chassis 102 is parallel with vibration isolation plate 130.

Power supply 310 may be positioned in between electronics retention folding mechanism 304. Power supply 310 is configured to receive electricity from a battery of the UAV and to configure the received electricity into a DC power that may be used by the computing components included in computing chassis 102.

Disruption signal generator 306 is coupled to vibration isolation plate 130 and vibration isolation plate 140. Disruption signal generator 306 may be configured to generate a communications disruption signal to temporarily disrupt the communications system of a target UAV. Disruption signal generator 504 may be configured to generate and transmit via disruption signal antenna 112 the communications disruption signal when a target UAV is identified. The communication disruption signal may be based on a sawtooth wave. A sawtooth wave is a non-sinusoidal wave with sharp ramps going upwards and then suddenly downwards or a non-sinusoidal wave with sharp ramps going downwards and then suddenly upwards. The power of a communication disruption signal at the peak of the sawtooth wave may be sufficient to jam the communications system of the target UAV, but due to the nature of the sawtooth wave, the communications system of the target UAV may be temporarily disabled because the power of the communication disruption signal will suddenly drop and ramp up again. As a result, the one or more processors of the target UAV may not realize it is under attack and not commence a communications failure procedure that cause the target UAV to return to a home location. The disruption signal generator 504 may cause a target UAV to fly in a hovering pattern.

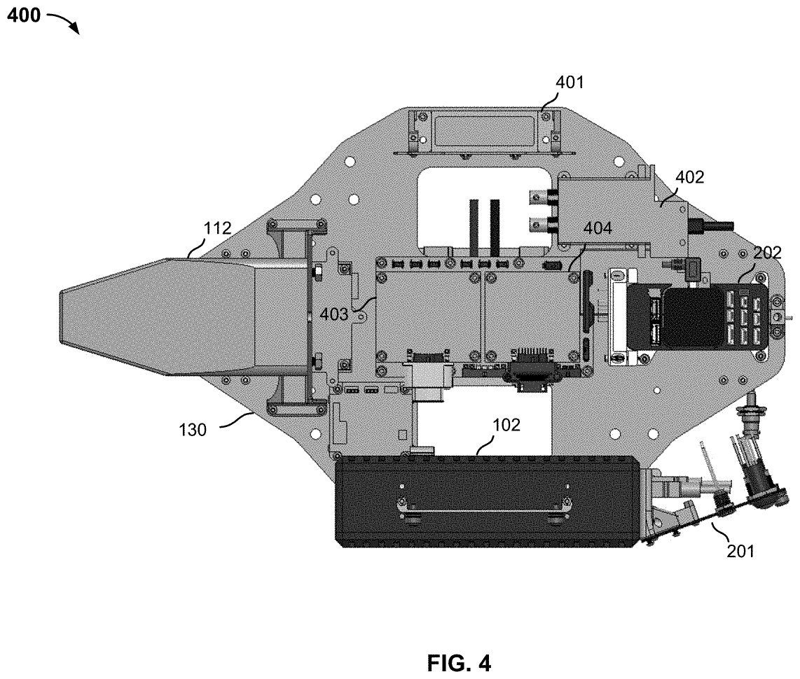

FIG. 4 is a diagram illustrating a top view of a top portion of an unmanned aerial vehicle in accordance with some embodiments. In the example shown, view 400 includes computing chassis 102, UI panel 201, flight controller module 202, first structural isolation plate 110, disruption signal antenna 112, resting bracket 401, signal converter 402, interdiction control module 403, and safety control module 404. In the example shown, the electronics retention folding mechanism has been pivoted such that computing chassis 102 is rotated ninety degrees. This enables an operator of the UAV to performance maintenance on one or more components that between first structural isolation plate 110 and computing chassis 102. Computing chassis 102 includes a handle. When the one or more fasteners are removed from the electronics retention folding mechanism, an operator may grab computing chassis 102 to remove computing chassis 102 from UAV 101.

Resting bracket 401 may support computing chassis 102 on a side opposite of electronics retention folding mechanism. When resting on the resting bracket, computing chassis 102 is parallel with vibration isolation plate 130.

Signal converter 402 is configured to data associated with a first format into a second format that is able to transmitted via the radio communications systems radio. For example, a video image obtained by visual detection system 111 may be converted from a video format (e.g., HDMI) into a second format (e.g., SDI).

Interdiction control module 403 may be configured to monitor signals received from interdiction sensor module 108 and determine whether to activate first net launcher 107a or second net launcher 107a based on the signals. The interdiction control module may be configured to automatically activate a net launcher to deploy a capture net when a set of predefined firing conditions are met. In other embodiments, the interdiction control module may receive a command from the CPU indicating when to deploy a capture net. The set of predefined firing conditions may include an object being identified as a UAV, the identified UAV being within a threshold range from UAV 101, and the identified UAV having an associated flight pattern (e.g., hovering flight pattern).

Safety control module 404 may be configured to interface with a user interface panel 201. Safety control module 404 is configured to arm/disarm UAV 101. For example, the user interface panel may receive from an operator an input indicating that first net launcher 107a and second net launcher 107b should be disarmed to allow the operator to inspect and/or perform maintenance on UAV 101. In response to receiving the input, safety control module 404 is configured to disarm first net launcher 107a and second net launcher 107b.

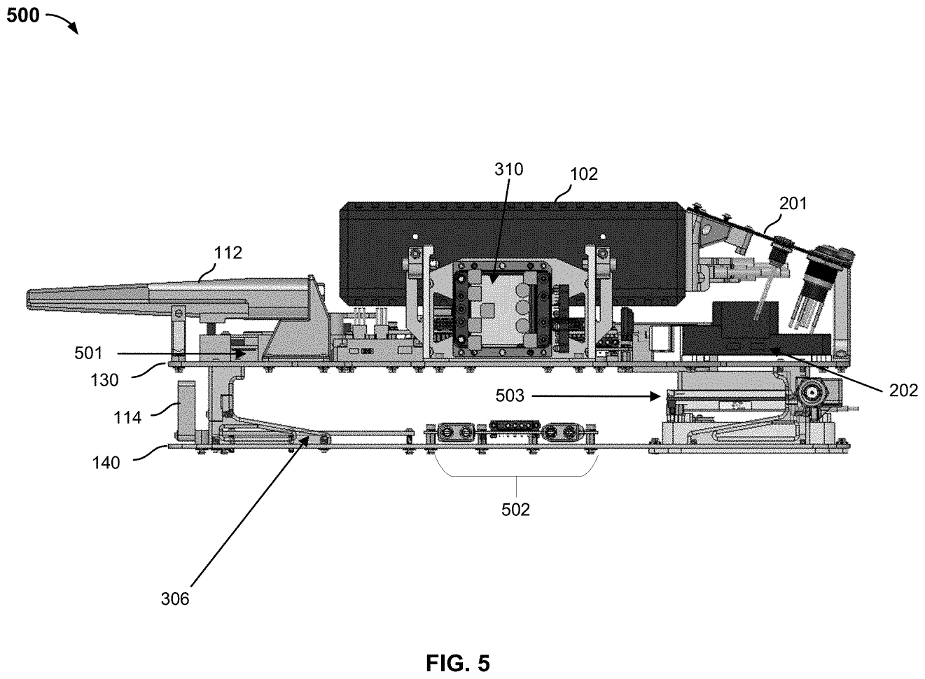

FIG. 5 is a diagram illustrating a side view of a vibration isolation module in accordance with some embodiments. In the example shown, side view 500 includes a vibrations isolation module comprising computing chassis 102, UI panel 201, flight controller module 202, vibration isolation plate 130, vibration isolation plate 140, flight recorder module 501, disruption signal generator 306, power supply 310, radio communications system 503, high power backbone 502, disruption signal antenna 112, and one or more cooling fans 114. Vibration isolation plate 130 may be referred to as a first isolation module plate and vibration isolation plate 140 may be referred to as a second isolation module plate.

Flight controller module 202, flight recorder module 501, disruption signal antenna 112, power supply 310, computing chassis 102, and UI panel 201 are mounted to vibration isolation plate 130. Radio communications system 503, high power backbone 502, and disruption signal generator 306 are mounted on vibration isolate plate 140.

Flight recorder module 501 is an electronic recording device that is configured to record specific UAV performance parameters. Flight recorder module 501 may be coupled to the CPU of computing chassis 102 and visual detection system 111. Flight recorder module 501 may be configured to record the CPU output in parallel with the image data associated with visual detection system 111. This allows the decisions made by the CPU based on the image data to be reviewed at a later time.

High power backbone 502 is a power distribution module and may be configured to distribute power between the one or more batteries of UAV 101 and the motors of UAV. It is comprised of a series of connections that allows the motors to be connected to the battery.

Radio communications system 503 is coupled to vibration isolation plate 130 and vibration plate 140. Radio communications system 503 is configured to transmit data associated with UAV 101 to a remote server/location. The data associated with UAV 101 may include network data, sensor data, and/or video data. For example, radio communications system 503 may transmit RADAR data, LIDAR data, SONAR data, and/or image data to the remote server/location. This enables the remote server to perform data analysis of the transmitted data. The data analysis may be performed while UAV 101 is in flight or after UAV 101 has completed a flight. In some embodiments, the remote server may perform data analysis on the transmitted data and provide to communications radio system 503 one or more control signals based on the data analysis. Radio communications system 503 is coupled to a heat sink, which allows the heat generated by radio communications system 503 to be dissipated.

Radio communications system 503 may be associated with a plurality of antennas (e.g., antenna 105a, antenna 105b, 205c). Each antenna may operate at a different frequency. This enables radio communications system 503 to switch between frequency channels to communicate. Radio communications system 503 may communicate with a remote server via antenna 105a. For example, radio communications system 503 may use the plurality of antennas to transmit the data associated with the one or more sensors associated with UAV 101. In some embodiments, radio communications system 503 is configured to transmit data using one of the plurality of antennas. In other embodiments, radio communications system 503 is configured to transmit data using more than one of the plurality of antennas in parallel.

In some embodiment, a frequency channel used by radio communications system 503 becomes noisy. In response to a frequency channel becoming noisy, radio communications system 503 is configured to select a different frequency channel to communicate. In some embodiments, radio communications system 503 is associated with three antennas (e.g., antenna 105a, 105b, 205c). The antennas may be approximately 90 degrees apart from each other (e.g., 90°±5°). The antennas to have a tripod configuration, which allows the antennas to have enough fidelity to transmit the needed bandwidth of data. For example, the tripod configuration allows the antennas to have sufficient bandwidth to transmit video data or any other data obtained from the one or more sensors of UAV 101.

The vibration isolation plate 140 may also be coupled to a voltmeter (not shown) and/or a current meter (not shown).

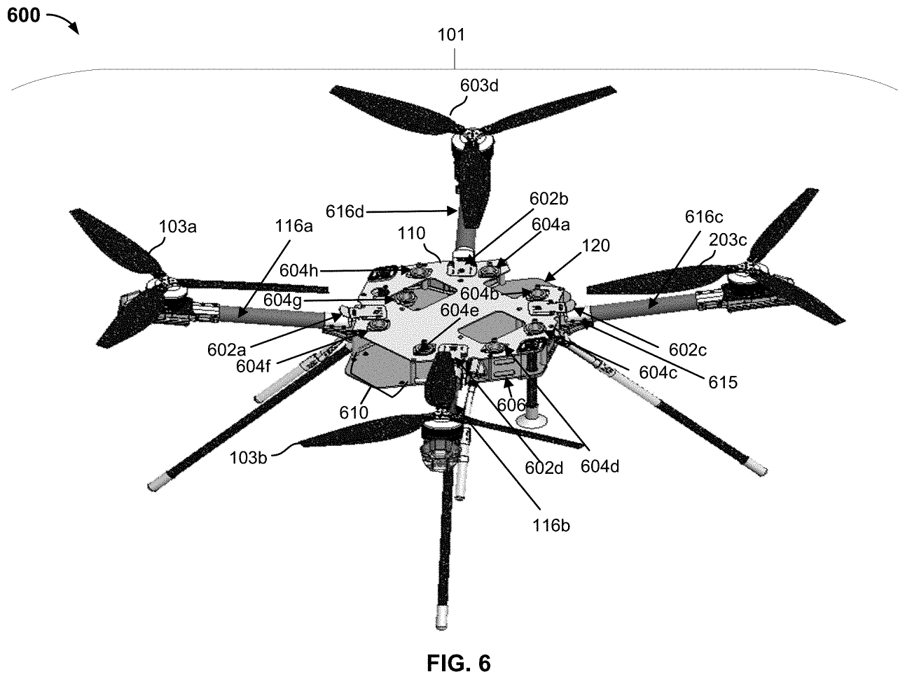

FIG. 6 is a diagram illustrating a view of a structural frame of an unmanned aerial vehicle in accordance with some embodiments. In the example shown, view 600 includes first structural isolation plate 110, second structural isolation plate 120, rotor bracket 615, side wall component 606, rotors 103a, 103b, 203c, 603d, rotor arms 116a, 116b, 616c, 616d, rotor arm clips 602a, 602b, 602c, 602d, opening 610, and vibration dampers 604a, 604b, 604c, 604d, 604e, 604f, 604g, 604h.

The structural frame comprises a top portion comprising first structural isolation plate 110 and a bottom portion comprising second structural isolation plate 120. Rotor arm clips 602a, 602b, 602c, 602d are mounted on first structural isolation plate 110. In the example shown, rotor arms 116a, 116b, 616c, 616d are mechanically locked into position via rotor arm clips 602a, 602b, 602c, 602d, respectively. Rotor arms 116a, 116b, 616c, 616d may be in a locked or unlocked state. The rotor arms may be in an unlocked state when UAV 101 is being stored or transported.

The structural frame includes side wall component 606 and one or more other side wall components. The side wall components provide support for the plurality for components supported by first structural isolation plate 110. The structural frame also includes rotor bracket 615 and a plurality of other rotor brackets. The rotor brackets also provide support for the plurality of components supported by first structural isolation plate 110 and are coupled to rotor arms 116a, 116b, 616c, 616d.

The structural frame also includes opening 610. The structural frame may include a plurality of other openings. Opening 610 allows ambient air to cool any component that is positioned between first structural isolation plate 110 and second structural isolation plate 120. Opening 610 also is configured to allow an isolation plate, such as isolation plate 140 to be positioned between first structural isolation plate 110 and second structural isolation plate 120.

Vibration dampers 604a, 604b, 604c, 604d, 604e, 604f, 604g, 604h are mounted on structural isolation plate 110. Vibration dampers 604a, 604b, 604c, 604d, 604e, 604f, 604g, 604h may be omnidirectional dampers. Vibration dampers 604a, 604b, 604c, 604d, 604e, 604f, 604g, 604h may be configured to reduce the amount of vibration to which a plurality of vibration sensitive components are subjected. The plurality of vibration sensitive components may include different electronics modules (e.g., components included in computing chassis 102, connectors, and heat sinks. The performance of the vibration sensitive components may degrade when subjected to vibrations. Vibration dampers 604a, 604b, 604c, 604d, 604e, 604f, 604g, 604h may be tuned to the specific frequency associated with a vibration source. The vibrations may be mechanical vibrations caused by the motors of the UAV (e.g., motors 104a, 104b) and the rotors of the UAV (e.g., rotors 103a, 103b). A vibration damper may be tuned to the mechanical vibrations caused by the motors of the UAV and the rotors 103a, 103b, 203c, and 603d. Vibration dampers 232a, 232b may be comprised of a vibration damping material, such as carbon fiber. In some embodiments, one or more vibration dampers may be included in between a motor and a motor mount.

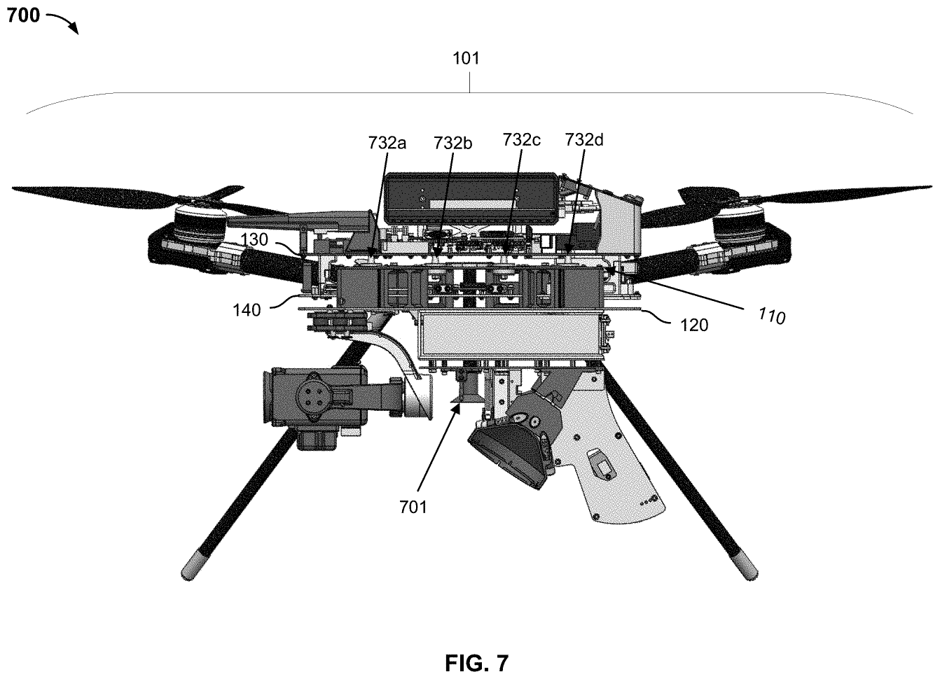

FIG. 7 is a diagram illustrating a side view of an unmanned aerial vehicle. In the example shown, view 700 depicts the vibration isolation module comprising vibration isolation plate 130 and vibration isolation plate 140 coupled to the structural frame comprising structural isolation plate 110, structural isolation plate 120. The plurality of computing components and noise generating components are coupled to the vibration isolation module. The vibration isolation module is coupled to the UAV structural frame via a plurality of vibration dampers 732a, 732b, 732c, 732d.

A width of vibration isolation plate 140 is small enough to fit in between an opening of the structural frame, such as opening 610. This allows the high noise generating components (e.g., the radio communications system 503 and the communications disruption signal generator 306) to be isolated from the computing components (e.g., computing chassis 102, interdiction control module 403, safety control module 404) by the first structural isolation plate 110.

A top vibration isolation plate of the isolation module, such as vibration isolation plate 130 may be positioned on top of the plurality of vibration dampers 732a, 732b, 732c, 732d. The plurality of vibration dampers 732a, 732b, 732c, 732d are configured to couple vibration isolation plate 130 to structural isolation plate 110. The structural frame of UAV 101 is coupled to the vibration sources, such as the motors and rotors of UAV 101, via the rotor brackets. The vibrations induced by the vibration sources will be absorbed by the vibration dampers 732a, 732b, 732c, 732d. The amount of vibration experienced components coupled to the isolation module (e.g., radio communications system 503, communications disruption signal generator 306, computing chassis 102, interdiction control module 403, safety control module 404) will be reduced because the vibrations will be absorbed by the vibration dampers 732a, 732b, 732c, 732d. The bottom vibration isolation plate of the isolation module, such as vibration isolation plate 140 is not directly coupled to second structural isolation plate 120 or any of the vibration sources. Thus, vibration isolation plate 140 does not directly experience vibrations from the vibration sources, but experiences the vibrations after they have been absorbed by vibration dampers 732a, 732b, 732c, 732d.

The configuration between the structural frame and the vibration isolation module helps not only to reduce the amount of vibration experienced by the computing components and noise generating components, but also to shield the computing components from the noise generated by the noise generating components. Such a configuration reduces the likelihood that UAV 101 will suffer a component failure due to vibration, noise, or EMI.

View 700 also depicts UAV 101 comprises persistent availability plug 701, which is configured to connect to a docking station. UAV 101 may be stored in a hangar or other storage facility. Persistent availability plug 701 may be connected to a power outlet associated with the hangar or other storage facility. The power connection may prevent the one or more batteries of UAV 101 from drawing power while UAV 101 is being stored. In other embodiments, the one or more batteries of UAV 101 may be recharged via persistent availability plug 701 while connected to a power outlet associated with the hanger or other storage facility.

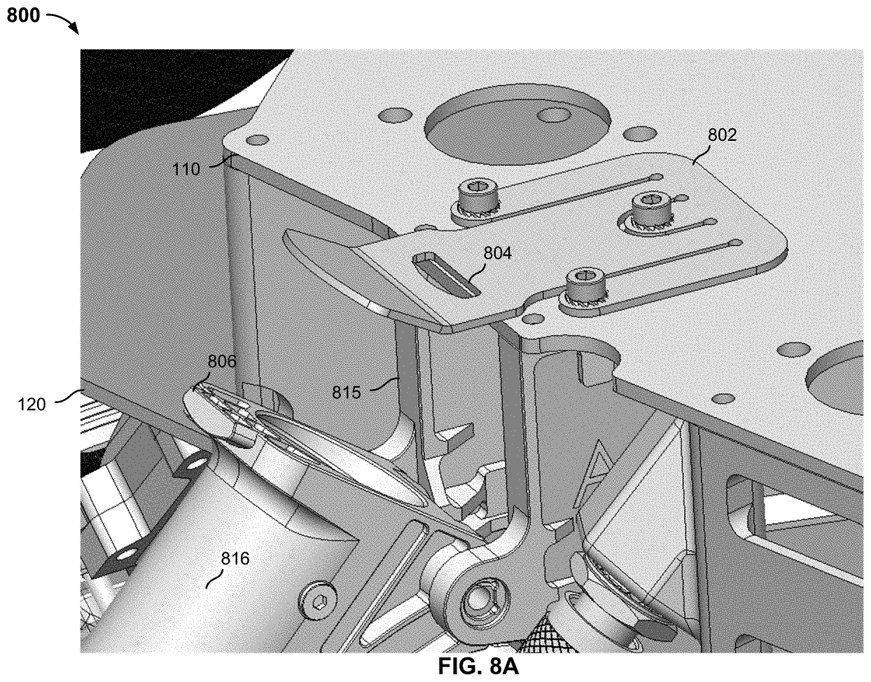

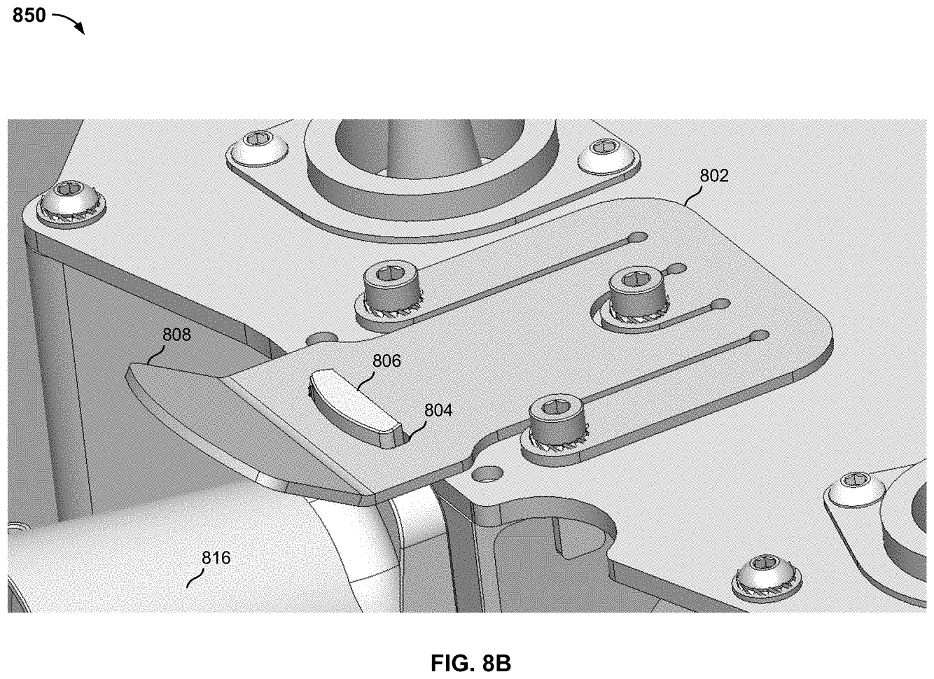

FIG. 8A is a diagram illustrating rotor arm clips in accordance with some embodiments. In the example shown, rotor arm 816 is in an unlocked state. A UAV may not fly when it is in an unlocked state. Rotor arm 816 may be in an unlocked state for storage and or transportation purposes. Rotor arm 816 is coupled to first structural isolation plate 110 and the second structural isolation plate 120 via bracket 815. Rotor arm clip 802 includes an opening 804. Opening 804 is configured to accept a bump 806 associated with rotor arm 816.

FIG. 8B is a diagram illustrating rotor arm clips in accordance with some embodiments. In the example shown, rotor arm 816 is in a locked state. A UAV may fly when rotor arm 816 is in a locked state. Rotor arm clip 802 is engaged with rotor arm 816. In the example shown, bump 806 associated with rotor arm 816 fits in the opening 804 of rotor arm clip 802. Rotor arm clip 802 includes a ramp portion 808. When an upward force is applied to ramp portion 808 and a downward force is applied to rotor arm 816, rotor arm 816 may become disengaged with rotor arm clip 802.

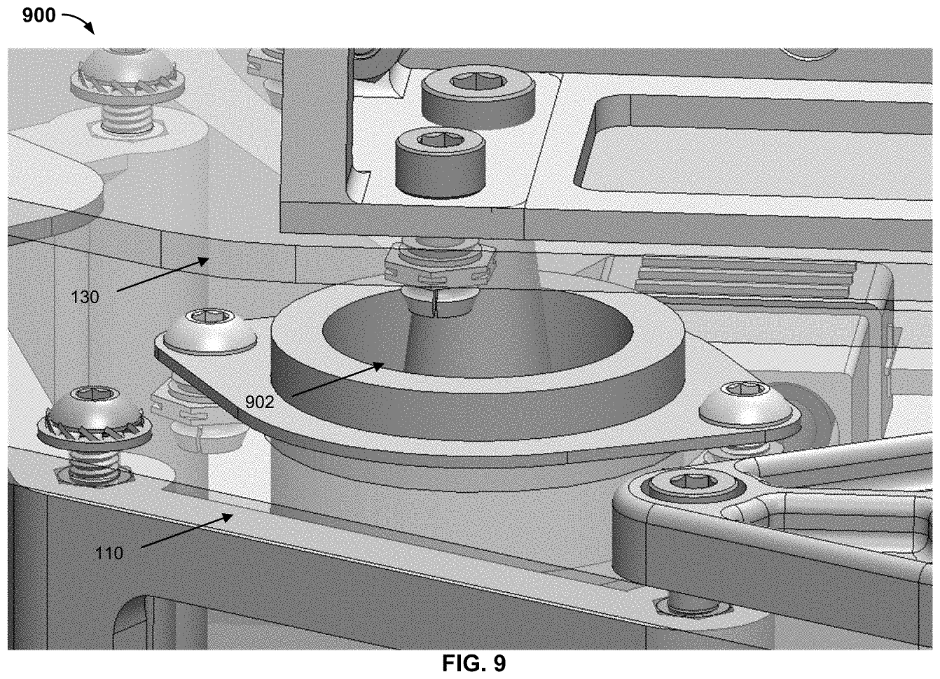

FIG. 9 is a diagram illustrating a vibration damper in accordance with some embodiments. In the example shown, vibration damper 902 is coupled to structural isolation plate 110 and vibration isolation plate 130. Vibration damper 902 may be an omnidirectional damper. Vibration damper 902 may be configured to reduce the amount of vibration to which a plurality of vibration sensitive components are subjected. The plurality of vibration sensitive components may include different electronics modules, connectors, and heat sinks. The performance of the vibration sensitive components may degrade when subjected to vibrations. Vibration damper 902 may be tuned to the specific frequency associated with a vibration source. The vibrations may be mechanical vibrations caused by the motors of the UAV (e.g., motors 104a, 104b) and the rotors of the UAV (e.g., rotors 103a, 103b). Vibration damper 902 may be tuned to the mechanical vibrations caused by the motors of the UAV and the rotors of the UAV. Vibration damper 902 may be comprised of a vibration damping material, such as carbon fiber.

A motor is mounted to a rotor arm via a motor mount. In some embodiments, one or more vibration dampers may be included in between a motor and a motor mount.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. An aerial vehicle system, comprising:
a signal generator;
a plurality of computing components;
a plurality of communication antennas;
a first structural component configured to at least in part block a noise signal generated by the signal generator from the plurality of computing components; and
a second structural component configured to at least in part block the noise signal generated by the signal generator from the plurality of communication antennas, wherein the first structural component and the second structural component form a portion of a structural frame of the aerial vehicle system.

2. The aerial vehicle system of claim 1, further comprising the structural frame, wherein the structural frame includes the first structural component, the second structural component, a plurality of rotor arm brackets, and a plurality of sidewall components.

3. The aerial vehicle system of claim 2, wherein each of the plurality of rotor arm brackets is coupled to a corresponding rotor arm.

4. The aerial vehicle system of claim 3, wherein the corresponding rotor arm is coupled to a rotor and a motor.

5. The aerial vehicle system of claim 1, wherein the first structural component is coupled to a plurality of vibration dampers.

6. The aerial vehicle system of claim 5, wherein the plurality of vibration dampers are configured to absorb vibrations generated by at least one rotor of the aerial vehicle system.

7. The aerial vehicle system of claim 1, wherein a plurality of vibration dampers couples together the structural frame with a vibration isolation module, wherein the vibration dampers are configured to reduce an amount of vibration propagated from the structural frame to the vibration isolation module.

8. The aerial vehicle system of claim 7, wherein the first structural component includes a first structural plate, wherein the plurality of vibration dampers couples together the first structural plate with a first isolation module plate of the vibration isolation module.

9. The aerial vehicle system of claim 7, wherein the vibration isolation module includes a first isolation module plate and a second isolation module plate.

10. The aerial vehicle system of claim 9, wherein the second isolation module plate is positioned in between the first structural component and the second structural component.

11. The aerial vehicle system of claim 10, wherein the signal generator is mounted on the second isolation module plate and the signal generator includes at least a communications disruption signal generator or a radio communications system.

12. The aerial vehicle system of claim 11, wherein one or more of the following are mounted on the second isolation module plate: the disruption signal generator, the radio communications system, or a power distribution module.

13. The aerial vehicle system of claim 1, wherein the signal generator is configured to generate a disruption signal with a frequency in the range of 2.1 GHz and 5.8 GHz.

14. The aerial vehicle system of claim 9, wherein the plurality of computing components are mounted on the first isolation module plate.

15. The aerial vehicle system of claim 7, wherein the vibration isolation module includes a hinge mounted computing module.

16. The aerial vehicle system of claim 1, wherein the plurality of computing components comprises at least one of: a computing module, an interdiction control module, a safety module, a flight recorder module, or a flight control module.

17. The aerial vehicle system of claim 1, wherein the first structural component and the second structural component include metallic material configured to at least in part block the noise signal generated by the signal generator.

18. The aerial vehicle system of claim 1, wherein the second structural component is configured to be a ground plane for the plurality of communication antennas.

19. The aerial vehicle system of claim 1, further comprising a plurality of landing struts, wherein a landing strut of the plurality of landing struts is associated with one of the plurality of communication antennas.

20. The aerial vehicle system of claim 2, wherein the first structural component is coupled to a plurality of rotor arm clips, wherein plurality of rotor arm clips are configured to engage a plurality of rotor arms via the plurality of rotor arm brackets.
